(19) United States
(12) Patent Application Publication
(10) Pub. No.: US 2003/0110108 A1
(43) Pub. Date: Jun. 12, 2003

(54) Systems and methods for asset financing utilizing fractionalization of property interests

(76) Inventor: Richard J. Sabella, New York, NY (US)

Correspondence Address: BUCKLEY, MASCHOFF, TALWALKAR, & ALLISON, 5 ELM STREET, NEW CANAAN, CT, 06840, US

(21) Appl. No.: 10/236,849

(22) Filed: Sep. 6, 2002

Related U.S. Application Data
(60) Provisional application No. 60/339,207, filed on Dec. 11, 2001.

(51) Int. Cl. G06F 17/60

(52) U.S. Cl. 705/35

(57) ABSTRACT

A system, method, apparatus, medium, and means for transferring property includes identifying a fractional interest in the property, identifying a recombination right in the property, pricing the fractional interest and the recombination right, and transferring the property upon receipt of a price of the fractional interest and the recombination right.

### CROSS-REFERENCE TO RELATED APPLICATIONS

This application hereby claims priority to and the benefit of U.S. Provisional Patent Application Serial Number 60/339,207 filed on Dec. 11, 2001, and U.S. patent application Ser. No. 10/134,586 filed on Apr. 29, 2002 for “SYSTEMS AND METHODS FOR CONVEYING COMMON LAW ESTATES IN PROPERTY USING DISREGARDED ENTITIES”, the contents of each of which are hereby incorporated by reference herein for all purposes.

### FIELD

The present invention relates to the financing of interests in tangible and intangible assets. In particular, some embodiments of the present invention relate to systems and methods for financing the acquisition (or refinancing a prior financing for acquisition) of property interests using the fractionalization of property interests.

### BACKGROUND

A variety of financing techniques have been developed to allow current or prospective property owners to finance the acquisition or ownership of property. For example, a property may be conveyed in fee simple in exchange for a purchase price. Many transactions, however, require that multiple parties provide funds to acquire the property. One technique that has been used to convey assets to multiple parties involves “securitization” of an asset (e.g., where assets are aggregated in a pool and equity interests in the asset pool are issued to investors). Often, this results in the fair value of the equity interests exceeding the value of the underlying pool of assets.

Existing techniques suffer from a number of deficiencies. For example, it would be desirable to provide systems and methods for financing interests in property which provide a high gross yield to a seller of the property while reducing the tax impact to a buyer. It would further be desirable to provide a system and method which allows secondary investors to participate via equity rather than debt interests, and in which the equity interests may be securitized. It would further be desirable to provide a transaction system and method which can be structured to manipulate economic and risk attributes to satisfy desires of different parties to the transaction. It would further be desirable to provide a system and method which provides participants with improved positions in the event of bankruptcy or default.

### SUMMARY

To alleviate problems inherent in the prior art, the present invention introduces systems, methods, apparatus, mediums, and means for financing the acquisition or ownership of property interests using fractionalization of property interests.

According to some embodiments, a system, method, apparatus, medium, and means for effecting the financing of a property interest includes identifying a fractional interest in the property, identifying a recombination right in the property, pricing the fractional interest and the recombination right, and transferring the fractional interest and the recombination right upon receipt of a price payable in respect of such interests.

According to some embodiments, the fractional interest is a term of years interest. In some embodiments, the term of years interest is a term of less than or equal to 10 years; in some embodiments, the term of years interest is a term of greater than or equal to 10 years.

According to some embodiments, a system and method for effecting the financing of a property interest further includes identifying a second fractional interest in the property. In some embodiments, the second fractional interest is a future interest in the property, where the future interest vests at an end of the term of years interest. In some embodiments, the recombination right is an option to acquire the future interest in the property. In some embodiments, the recombination right may consist of a reversion, conditional limitation or similar common law or contractual provision that has the legal effect of terminating a holder's interest or estate in property.

According to some embodiments, a price of the recombination right is determined based at least in part on a desired return on investment for a holder of the second fractional interest. In some embodiments, the second fractional interest is a residual interest and the recombination right is an option to acquire the residual interest.

According to some embodiments, a system and method for effecting the financing of a property interest further includes identifying at least a second fractional interest in the property, wherein the recombination right includes a right to recombine the fractional interest and the at least second fractional interest. According to some embodiments of the present invention, means for and computer program code are provided for determining the price and other parameters of the first fractional interest and the second fractional interest and the recombination right.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a transaction flow diagram according to some embodiments of the present invention.

FIG. 2 is a transaction flow diagram illustrating a financing of a property interest through fractionalization of property rights according to one example of the present invention.

FIG. 3 is a transaction flow diagram illustrating a financing of a property interest through fractionalization of property rights according to another example of the present invention.

FIG. 4 is a flow chart of a method performed by (or on behalf of) a holder of a property to facilitate the sale of such property utilizing features of some embodiments of the present invention.

FIG. 5 is a flow chart of a method performed by (or on behalf of) a prospective purchaser of a property to facilitate the acquisition of such property according to some embodiments of the present invention.

FIG. 6 is a block diagram of a transaction device according to an embodiment of the present invention.

FIG. 7 is a tabular representation of a portion of property database according to an embodiment of the present invention.

FIG. 8 is a tabular representation of a portion of a transaction database according to an embodiment of the present invention.

FIGS. 9A-9E are illustrative user interfaces that can be displayed on a transaction device pursuant to some embodiments of the present invention.

### DETAILED DESCRIPTION

Embodiments of the present invention relate to transaction methods and systems for the financing of interests in “property”. As used herein, the term “property” is used to refer to rights in any type of tangible or intangible asset. Throughout the remainder of this disclosure, examples will be given primarily focusing on real property transfers; however, upon reading this disclosure, those skilled in the art will recognize that features of embodiments of the present invention may be used to transfer rights in other types of property, such as, for example personal property, fixtures, intangible assets or the like.

As used herein, the term “seller” will be used to refer to the individual or entity (or its agent or designee) desiring to transfer ownership of property using techniques of the present invention. The term “primary investor” is used to refer to the individual or entity (or their agent or designee) desiring to acquire a primary interest in the property using techniques of embodiments of the present invention. As will be discussed, the primary investor may acquire several different interests in the property which ultimately result in the primary investor owning the property outright (e.g., fee simple ownership ). The term “secondary investor” is used herein to refer to the individual or entity (or its agent or designee) desiring to acquire a secondary interest in the property using techniques of the present invention. Sellers, primary investors, and secondary investors may be any of a number of different types of individuals or entities, including for example: corporations, limited liability companies, partnerships, trusts, or other type of organization. Features of embodiments of the present invention will be described by first referring to a variety of transaction flows.

Transaction Flow Diagram

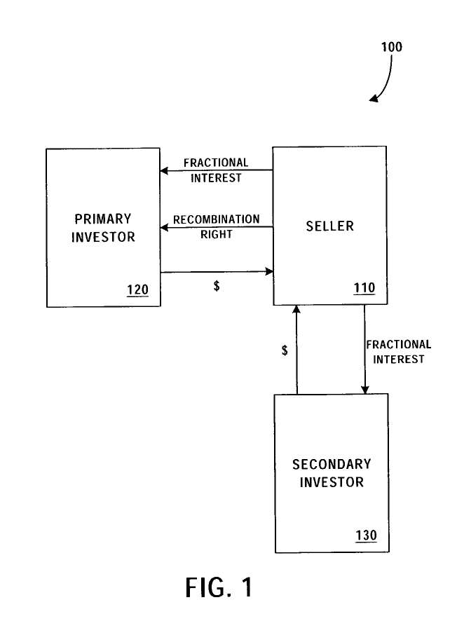

Turning now in detail to the drawings, FIG. 1 is a transaction flow diagram 100 according to some embodiments of the present invention. As depicted by the transaction flow of FIG. 1, certain transactions pursuant to embodiments of the present invention involve a seller 110, a primary investor 120 and a secondary investor 130. Seller 110 holds title to a property (not shown), such as, for example, a parcel of real estate or some other type of tangible or intangible property. Seller 110 transfers ownership of the property by conveying one fractional interest in the property to primary investor 120 and a second fractional interest in the property to secondary investor 130. In exchange for the fractional interests, the seller receives some form of payment (e.g., cash, barter, exchange, etc.), the valuation of which will be described further below.

In addition to the fractional interests, seller 110 conveys a recombination right to primary investor 120 (and receives some form of payment in return). This recombination right, as will be described further below, allows the primary investor to acquire the second fractional interest (the fractional interest conveyed to the secondary investor) if so desired by the primary investor. The primary investor may also reconvey the recombination right to a third party, providing the third party with the right to acquire the second fractional interest.

Pursuant to some embodiments of the present invention, the resulting transfer of rights provides a number of benefits to participants to the transaction, including, but not limited to, a greater gross recovery to the seller, a reduced tax impact on the primary and secondary investors, and improved bankruptcy protection to both the primary and secondary investors. In some embodiments, secondary investor 130 may be a trust, the beneficiaries of which may hold interests such as residual interest debt and equity securities. Secondary investor may also be formed as a corporation, a partnership or other entity. In some embodiments, secondary investor 130 may receive debt and/or equity financing from other parties.

Both primary investor 120 and secondary investor 130 may be organized as any of a number of different forms. For example, primary investor 120 may be structured as a corporation, an LLC, a real estate investment trust (REIT) or other tax-advantaged entity. The secondary investor 130 may also be organized as any of a number of different forms (including as a corporation, LLC, trust, or the like). Further, secondary investor 130 may be formed to operate as: an investment business through which residual interests could be purchased and securitized or held for appreciation; a management or servicing business where residual interests as well as other subordinated realty interests could be managed; or as an advisory business where fee income could be generated by structuring transactions for other realty investors.

Throughout this disclosure, example structures are described in which embodiments of the present invention are described as being used to finance the acquisition of property. Those skilled in the art, upon reading this disclosure, will recognize that features of embodiments of the present invention may be used to structure other transaction types. For example, embodiments of the present invention may be used to structure investment rounds (e.g., such as so-called “mezzanine” or “B rounds”) as equity as opposed to debt, thereby achieving economic characteristics similar to those of zero coupon bonds (but without being subject to the income recognition rules governing original issue discount (OID). Further, investment rounds structured using embodiments of the present invention may be created with standardized terms and characteristics that will facilitate the securitization of such positions.

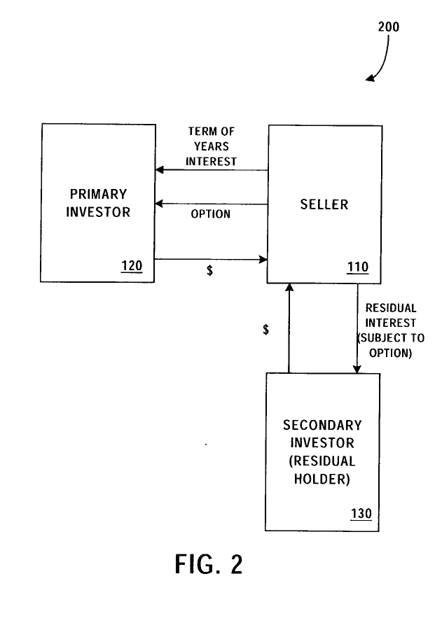

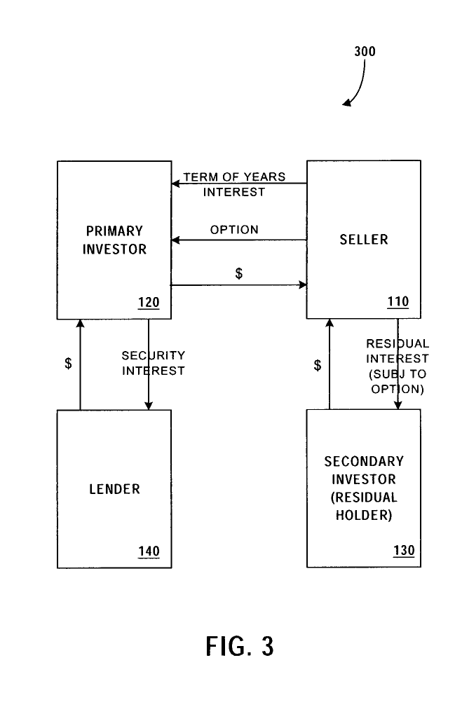

Examples of transactions conducted pursuant to some embodiments of the present invention will now be described by referring to FIGS. 2 and 3. Referring first to FIG. 2, a transaction flow diagram 200 is shown depicting a transaction involving the sale of, for example, a real estate parcel. The property is owned by seller 110 who has agreed to sell the property to primary investor 120.

In the transaction depicted in FIG. 2, seller 110, primary investor 120 and secondary investor 130 have agreed that the property will be conveyed using two fractionalized interests: a first interest to primary investor 120, and a second interest to secondary investor 130. In particular, in the example depicted, the first interest is a term of years interest giving primary investor 120 a present possessory interest in the property for an agreed-upon term of years. In the example, the second interest is a residual interest providing secondary investor 130 a future interest in the property (e.g., the right to a possessory interest at the end of the term of years interest granted to primary investor 120).

In addition to the two fractionalized interests, the transaction depicted in FIG. 2 also includes a recombination right granted to primary investor 120. Here, the recombination right is an option to acquire the residual interest granted to secondary investor 130. In some embodiments, the terms of the first and second fractional interests, as well as the terms of the recombination right, are established and priced to provide a number of different scenarios. The participants can then select the scenario that satisfies their desired level of risk and return.

Applicant has found that a term of years interest having a relatively short duration (e.g., less than 10 or 15 years) provides desirable benefits to primary investor 120, seller 110 and secondary investor 130. For example, use of a term of years interest of less than about 15 years allows primary investor 120 to amortize the cost of the term of years interest over a shorter period than he would otherwise be entitled to if he took full title to the property (e.g., fee simple). Use of a relatively short term of years interest also allows more predictable and ready pricing of the fractionalized interests and recombination rights. Applicant believes this predictability in pricing will permit the establishment of a meaningful and liquid market for such fractionalized interests and recombination rights.

Once the parties have agreed upon acceptable terms, primary investor 120 pays an agreed-to amount to seller 110 (in exchange for the term of years interest and in exchange for the option) and secondary investor 130 pays an agreed-to amount to seller 110 (in exchange for the residual interest). According to some embodiments of the present invention, the total amount received by seller 110 is approximately equal to or greater than the market value of the property. As a result, from the perspective of a seller, sale of a property using techniques of the present invention is at least as desirable as sale of a property using traditional conveyancing techniques. From the perspective of primary investor 120 and secondary investor 130, acquisition of a property using techniques of the present invention is preferable to acquisition using traditional financing and conveyancing techniques as a result of improved tax treatment, pricing, and flexibility. Further, by appropriately structuring and pricing the recombination right, secondary investor 130 may achieve a desired return on its original investment and the advantages in respect thereof.

Once the fractionalized interests and the recombination right have been acquired by primary and secondary investors 120, 130, the interests are held according to their terms. For example, in an embodiment where primary investor 120 acquired a term of years interest having a duration of 10 years, the recombination right may be an option to acquire the residual interest of secondary investor 130 at the end of the 10 year term or at specified times prior thereto. If primary investor 120 chooses to exercise this option, an agreed upon or formula based price (agreed at the time the option and fractional interests are created) must be paid by primary investor 120 to secondary investor 130 to exercise the option. Upon exercising the option, primary investor 120 acquires title to the property (e.g., ownership in fee simple absolute ). If primary investor 120 elects not to exercise the option, it may sell or otherwise convey the option to a third party. The result is a transaction system and method which provides desirable tax, financial, risk, and flexibility benefits to participants.

A more detailed example of some embodiments of the present invention will now be described by referring to FIG. 3 where a transaction flow diagram 300 is shown. Transaction flow diagram 300 includes a seller 110, a primary investor 120, a secondary investor 130 and a lender 140. Transaction flow diagram 300 will be described using an example of a conveyance of a specific property. For the purposes of illustration, the specific property owned by seller 110 is a commercial property having a market value of $1,000,000 ($1M) and which generates a net operating income of $100,000 per annum. Seller 110 may choose to sell the property via conventional means and receive $1M for a conveyance in fee simple absolute, or he may utilize features of embodiments of the present invention to receive at least $1M while providing enhanced tax treatment and other advantages to the primary investor and the secondary investor in respect of the property. In the example, seller 110 chooses to utilize features of embodiments of the present invention to convey the property using fractionalized interests.

A primary investor 120 and a secondary investor 130 are identified. Primary and secondary investors 120, 130 wish to take fractionalized interests in the property, and primary investor 120 also desires a recombination right which will allow him to recombine the fractionalized interests into a full estate. The parties review a number of possible terms for the transaction, and agree that the fractionalized interest taken by primary investor 120 shall be a term of years interest of either 5, 10 or 15 years (providing the primary investor with a present possessory right for 5, 10 or 15 years), and the second fractionalized interest taken by secondary investor 130 shall be a residual interest arising at the end of the 5, 10 or 15 year period. The parties also agree that the residual interest is taken subject to an option held by primary investor 120. The parties price the interests as follows. If the first fractional interest is a 10 year term of years, and the first investor desires a 12% rate of return, while the second investor wishes a 15% rate of return, the price of the term of years interest may be set at $630,000, the price of the option set at $40,000 and the price of the residual interest set at $330,000 (providing the seller with a total sales price of $1M).

Alternatively, the parties may structure the pricing such that secondary investor 130 receives a 17% annual rate of return while the first investor receives a 10% annual rate of return. In such an example, the pricing may be broken down as follows: the 10 year term of years interest is $688,000, the option is $32,000 and the residual interest is $280,000.

Pricing for a 5 year term of years interest may also be investigated by the parties. As an example, where primary investor 120 desires at least an 8% annual rate of return on investment and the secondary investor desires at least a 15% annual rate of return, the price of the term of years interest may be $422,000, the option $46,000, and the residual interest may be $532,000. Pricing for a 15 year term of years interest may also be investigated by the parties. As an example, where the primary investor desires at least a 12% annual rate of return, and secondary investor 130 desires at least a 15% annual rate of return, the pricing may be: $795,000 for the term of years interest, $14,000 for the option, and $191,000 for the residual. Calculation of these prices may depend on a number of different variables and assumptions, some of which will be discussed further below. Those skilled in the art, upon reading this disclosure, will recognize that other pricing options and combinations may also be used to arrive at deal terms which satisfy the risk and price objectives of different parties to the transaction.

In the example discussed in conjunction with FIG. 3, assume that the parties agree to adopt a structure where the term of years interest is a term of 10 years, with a 15% calculated annual return to the second investor and a 12% calculated annual return to primary investor 120. In the example, the primary investor receives financing from lender 140 to satisfy the primary investor's obligation of $630,000. In some embodiments, secondary investor 130 may agree to subordinate its interest to that of lender 140. Absent such an agreement, the interests of secondary investor 130 will likely be senior to those of lender 140. In some embodiments, it may be desirable to enter into such a subordination agreement to provide credit support to lender 140.

Those skilled in the art will recognize that the terms of such a subordination agreement could be tailored by agreement among primary investor 120, lender 140 and secondary investor 130 to achieve various credit ratings or economic results or to transfer value to or from the loan investment of lender 140.

At the end of the 10 year term of years interest (or at some other times during the term of years interest), primary investor 120 may exercise its option to acquire the residual interest from secondary investor 130, giving primary investor an estate in fee simple. The option exercise price is an amount specified, or the result of a formula, negotiated at the time of creation of the fractional interests and is a price which will generate a desired yield for the secondary investor 130. In some embodiments, primary investor 120 may sell the option and retain any gain (all of which is taxed at long-term rates) which accrues to the option. Whether primary investor 120 exercises or sells its option, it is in a better position than it would have been in had it acquired title to the property at the outset. For example, using techniques of the present invention, primary investor 120 benefits because there is no tax recapture of cost recovery deductions (using conventional transactions, the investor would be subject to tax recapture on previously taken deductions). Further, primary investor 120 will benefit by having a significantly greater tax write-off than it would if the property had been taken in fee simple.

Another example of a transaction which may be structured and implemented pursuant to embodiments of the present invention will now be described, generally referring to FIG. 3. In this further example, a primary investor 130 identifies and contracts to purchase a series of single member limited liability companies, each of which owns a single parcel of net leased real estate. The total value of all of the real estate is $100 million. Each limited liability company (LLC) owns its own parcel in fee simple absolute and has mortgaged its real estate and the rents to come due under the applicable lease to an unrelated mortgage lender. The aggregate principal balance of the mortgage loans is $80 million. Most of the loans require amortization of the principal amount on a basis equivalent to that of a 25 year level payment mortgage loan.

The primary investor identifies two secondary investors 130a, b to participate in the transaction. The first of the two secondary investors 130a wishes to acquire a 9 year term of years interest in the realty (subject to the mortgage loans) together with an option to acquire the balance of the fee simple absolute estate (subject to the mortgage loans) at a future time. The second of the two secondary investors 130b wishes to acquire the residual interest in the realty, subject to the mortgage loans and the option mentioned above.

In the example, the parties utilize features of embodiments of the present invention and enter into a transaction having the following structure. The primary investor 120 forms a new LLC (“Newco”). Newco purchases from the promoter by assignment the contract rights to acquire the equity interests in the LLC companies that are the owners of the realty and the obligors in respect of the mortgage debt. To fund the $20 million needed to close on the acquisition of the LLC equity interests, the promoter sells a 9 year term of years in the equity interest of Newco to secondary investor 130a, together with an option to acquire the balance of the equity in Newco. The purchase price for the term of years and the option is $16.5 million. The purchase price for the residual interest is $4.5 million. Fees and expenses of the primary investor and other closing costs amount to $1 million. The option to acquire the residual interest in Newco's equity is exercisable in the fifth, sixth, and seventh years after the closing of the transaction. The option price is fixed at the inception of the transaction at an amount that will result in an overall compounded return to the holder of the residual interest of 18.5% per annum.

In this structure, each of the participants enjoy economic benefits. For example, the holder of the estate for years is regarded as the owner of the realty for tax purposes during the term. The owner of the term of years interest is regarded (for tax purpose) as the obligor under the underlying mortgage debt and may include in its basis for amortization the entire principal amount of the debt as well as its cash equity investment in the transaction.

Certain advantages realized by participants in structures established pursuant to the present invention are achieved through the use of a residual interest in a transaction. For example, the residual interest will likely be the most senior and secure position in the capital structure of an asset. It will eventually vest in possession at the expiration of the term of years interest even if the borrower defaults on its senior credit facility (provided the holder has not agreed to subordinate the residual interest to the lien of the senior lender) or declares bankruptcy or ceases to exist. As another example, the residual interest is generally immune to loss or cramdown in a borrower bankruptcy. The rights of a residual interest holder are fully vested ownership interests and are not debt obligations. As a result, the bankruptcy rules governing executory interests and adequate protection are not applicable. Further, because transactions pursuant to embodiments of the present invention are not loans, the holder of the residual interest does not bear the risks and costs associated with foreclosure or lender liability claims. Those skilled in the art, upon reading this disclosure, will recognize that other transactions may be structured and performed using techniques of embodiments of the present invention, and that other pecuniary and administrative advantages may be enjoyed by participants in the transaction.

Transaction Methods

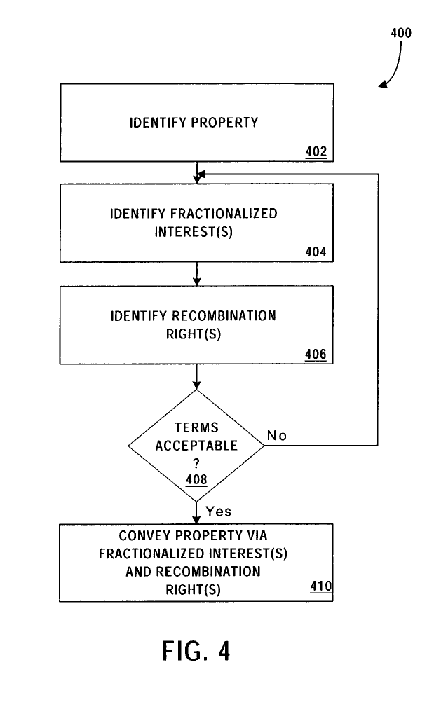

FIG. 4 is a flow chart of a transaction method 400 performed by a seller to convey, or a purchaser to acquires property according to some embodiments of the present invention. The flow charts in FIG. 4 and the other figures described herein do not imply a fixed order to the steps. Embodiments of the present invention can be practiced in any order that is practicable.

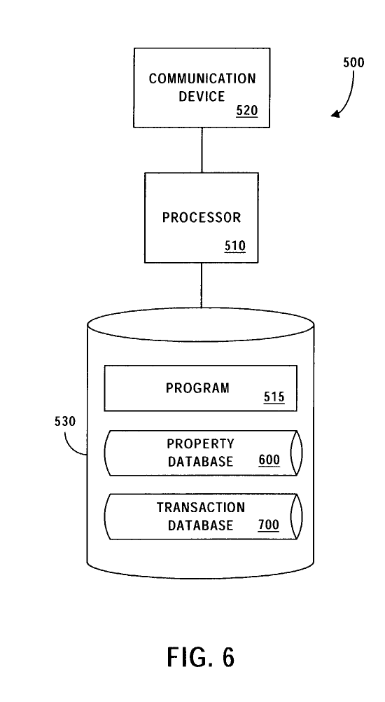

Transaction method 400 may be performed by a seller or a purchaser or by an agent of either or by an intermediary (such as a broker, etc.) or agent of an intermediary. In some embodiments, some or all steps of transaction method 400 may be performed by a transaction device such as the transaction device depicted and discussed in conjunction with FIG. 6 below. Some or all of the steps of transaction method 400 may be performed by or on behalf of seller or purchaser, by or on behalf of an intermediary such as a broker, or by or on behalf of one or more investors.

Transaction method 400 begins at 402 where a property to be sold and financed is identified. As mentioned above, any of a number of different types of property may be conveyed and financed using features of embodiments of the present invention. The property may be identified by any of a number of manners used in the art. For example, where the property to be conveyed is real property, the property may be identified by its legal description. The identification of the property is used to identify a price of the property and other characteristics of the property which may be used to establish pricing and other terms of the transaction. For example, if the property is commercial real estate, processing at 402 may include identifying the net operating income that an owner of the property may enjoy. Processing at 402 may include the identification of other relevant attributes of the property (e.g., whether any liens or encumbrances exist, etc.) which may be useful or necessary to establish terms to convey interests in the property.

Once the property and relevant attributes of the property have been identified, processing continues at 404 where fractionalized interest(s) are identified. In some embodiments, two fractionalized interests are identified—a first interest providing an investor with a present possessory interest, and a second interest providing a second investor with a future interest in the property. For example, in one embodiment providing desirable results, a term of years interest and a residual interest are identified at 404. Identification at 404 may include generating a number of variations of terms of each of the fractionalized interests. In some embodiments, more than two fractionalized interests are identified at 404 (e.g., one or more term of years interests may be granted along with one or more future interests). Identification of fractionalized interests at 404 may include receiving information from one or more investors and the seller regarding the financial and risk objectives of each party.

Processing continues at 406 where one or more recombination rights are identified. Processing at 404 and 406 may be performed in concert or at different times. In some embodiments, identification of recombination rights depends, at least in part, on the property and property characteristics identified at 402 as well as information received from each of the participants. For example, identification of fractionalized interests and recombination rights at 404 and 406 may depend on the market value of the property, the operating income generated by the property (if any), the amount of funds available to a primary investor, the return desired by the primary and secondary investors, and other factors.

Terms of the fractionalized interest(s) and recombination right(s) are presented to the participants at 408 for a determination of whether the terms are acceptable. If they are, processing continues to 410. If the terms are not acceptable, processing may revert to 404 where the terms are reconfigured or the interests and recombination rights are restructured. In some embodiments, the participants are presented with one or more options of terms of each of the interests and rights. The final terms may be agreed upon by each of the participants, allowing the generation of terms which satisfy a variety of different objectives.

Once the participants have agreed upon a deal structure (including terms of the fractionalized interests and recombination right(s)), processing continues at 410 where the property identified at 402 is conveyed via the fractionalized interest(s) and recombination right(s) identified at 404 and 406. In some embodiments, processing at 410 involves providing a primary investor with a present possessory right in the property for a term of years, and providing a secondary investor with a residual right at the end of the term of years, subject to an option held by primary investor 120 to acquire the residual right. Processing at 410 includes the payment of agreed upon amounts associated with each of the interests and recombination right(s).

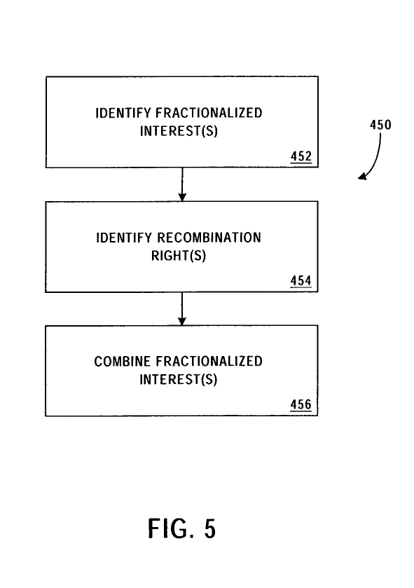

FIG. 5 is a further transaction flow diagram 450 illustrating a recombination transaction conducted pursuant to some embodiments of the present invention. Some or all of the steps of flow diagram 450 may be performed using a transaction device such as the transaction device of FIG. 6. Some or all of the steps of transaction flow diagram 450 may be performed by or on behalf of seller or purchaser, by or on behalf of an intermediary such as a broker, or by or on behalf of one or more investors. Pursuant to some embodiments of the present invention, the process depicted by flow diagram 450 takes place after property has been conveyed using techniques of the present invention (e.g., using the process described in conjunction with FIG. 4, above), and before the expiration of the recombination right(s) granted when the property was conveyed. For example, the steps of transaction flow diagram 450 may occur before the expiration of a first fractional interest by a primary investor wishing to acquire a second fractional interest which was granted to a secondary investor.

Processing begins at 452 where one or more fractionalized interest(s) are identified which were created pursuant to embodiments of the present invention. For example, in an embodiment where two fractionalized interests were created to convey property, the two fractionalized interests are identified at 452. Processing at 452 may also involve determining whether the fractionalized interests are still in force. For example, if the first fractionalized interest was a term of years interest, processing at 452 may include determining whether the term of years has lapsed. If so, the fractionalized interests cannot be recombined, and processing halts.

Otherwise, processing continues to 454 where the recombination right(s) are identified which were created along with the fractionalized interest(s) identified at 452. For example, in an embodiment where two fractionalized interests were created to convey property, and a recombination right giving a primary investor the right to acquire the second fractionalized interest, processing at 454 may involve identifying the terms of the recombination right. Processing at 454 may also include determining whether the recombination right remains exercisable. For example, a recombination right may expire or have preconditions to exercise. If the recombination right is no longer exercisable, processing halts. Otherwise, processing continues to 456 where the fractionalized interest(s) are combined. Processing at 456 may include requiring primary investor 120 to perform certain actions to combine the fractionalized interest(s). For example, if the recombination right is an option to acquire the second fractionalized interest, exercisable by paying an agreed-to amount by a date certain, processing at 456 may include enforcing the terms of the option. If the terms of the option are satisfied, the fractionalized interests are recombined, resulting in full ownership of the property in the primary investor.

In some embodiments, a primary investor may choose to not recombine the fractionalized interests, and may instead transfer the recombination right to a third party. This may result in ownership of the property vesting in the third party (if the third party properly exercises the recombination right).

Transaction Device

FIG. 6 illustrates a transaction device 500 that may be associated with, for example, seller 110 and/or primary investor 120 and/or secondary investor 130 shown in FIG. 1. In some embodiments, transaction device 500 is associated with an intermediary (such as a broker or the like) interacting with each of the parties 110, 120 and 130. Transaction device 500 includes a processor 510, such as one or more INTEL® Pentium® processors. The processor 510 is coupled to a communication device 520 adapted to communicate via a communication network (not shown in FIG. 6). The communication network may be, for example, a Local Area Network (LAN), a Metropolitan Area Network (MAN), a Wide Area Network (WAN), a proprietary network, a Public Switched Telephone Network (PSTN), a wireless network, and/or an Internet Protocol (IP) network such as the Internet, an intranet, or an extranet.

When transaction device 500 is associated with a seller, communication device 520 may be used to communicate, for example, with one or more investor devices (e.g., operated by or on behalf of primary and/or secondary investors) and/or lender devices (e.g., operated by or on behalf of a lender providing funds in the transaction). When transaction device 500 is associated with an investor (such as a primary or secondary investor), communication device 520 may be used to communicate, for example, with a seller device, other investor devices, and/or lender devices. When transaction device 500 is associated with an intermediary, such as a broker, communication device 520 may be used to communicate, for example, with seller devices, investor devices, and/or lender devices. In some embodiments, transaction device 500 is operated by a service provider operating to structure transactions on behalf of parties using techniques of the present invention.

Processor 510 is also in communication with a storage device 530. Storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 530 stores a program 515 for controlling processor 510. Processor 510 performs instructions of program 515, and thereby operates in accordance with the present invention. As an example, when transaction device 500 is associated with a seller, processor 510 may help to receive information regarding the property, receive assumption and other information from a primary and a secondary investor, identify fractionalized interests, and identify recombination right(s). Processor 510 may generate a number of different scenarios and transmit these scenarios to the various parties for their approval.

As another example, when transaction device 500 is associated with an investor, processor 510 may help to receive information regarding a property, receive information from other participants in the transaction, identify fractionalized interests, and identify recombination right(s). Processor 510 may generate a number of different scenarios and transmit these scenarios to other parties for their approval.

As another example, when transaction device 500 is associated with an intermediary or service provider, processor 510 may help to receive information from all of the participants, including information regarding the property, information regarding assumptions and desires of the parties. Processor 510 may help to identify fractionalized interests and recombination right(s), and communicate this information to the participants. Processor 510 may also help to generate a number of scenarios and transmit these scenarios to the participants for their approval.

As used herein, information may be “received” by or “transmitted” to a software application or module within transaction device 500 from another software application, module, or any other source.

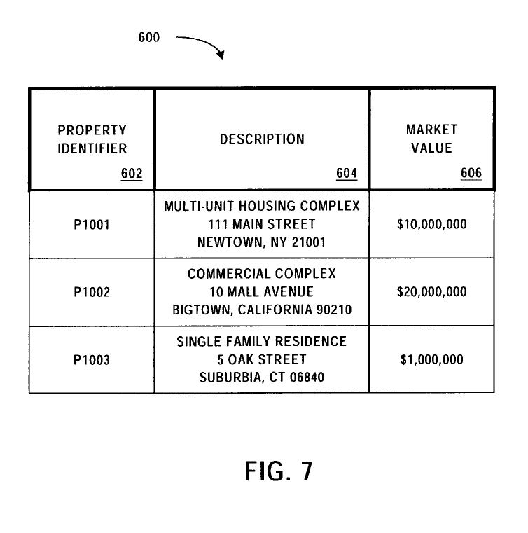

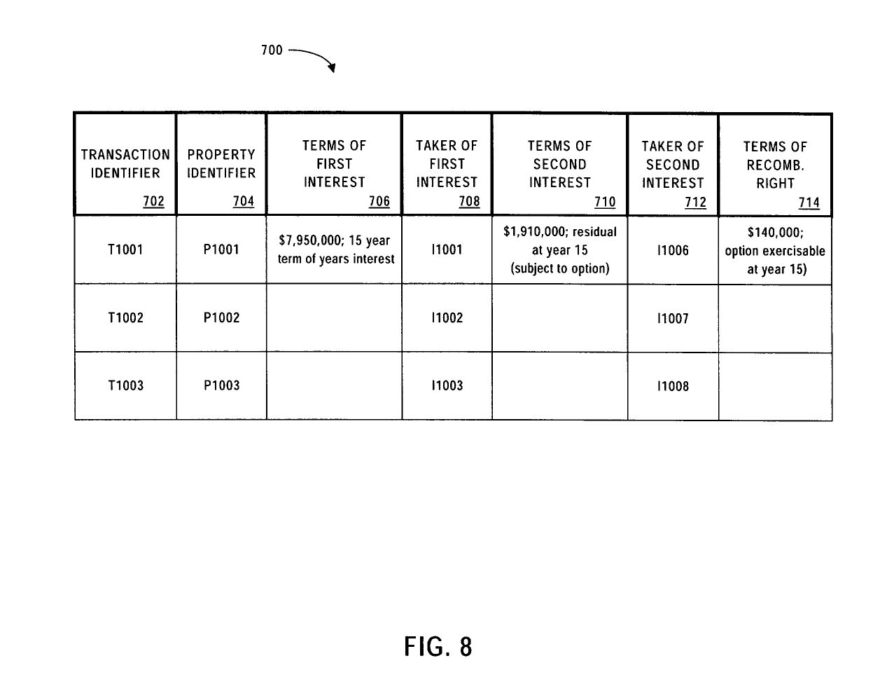

As shown in FIG. 6, storage device 530 also stores a property database 600 (described with respect to FIG. 7) and a transaction database 700 (described with respect to FIG. 8). Examples of databases that may be used in connection with transaction device 500 will now be described in detail. The illustrations and accompanying descriptions of the databases presented herein are exemplary, and any number of other database arrangements could be employed besides those suggested by the figures.

Property Database

Referring to FIG. 7, a table represents the property database 600 that may be stored at the transaction device 500. The table includes entries identifying insurance asset cash flows that have been, or will be, transferred in accordance with the present invention. The table also defines fields 602, 604, 606 for each of the entries. The fields specify: a property identifier 602, a description 604, and a market value 606. The information in property database 600 may be created and updated, for example, based on information received from an owner of a property, a broker, or some other source.

Property identifier 602 may be, for example, an alphanumeric code associated with a particular piece of property or group of properties that has been, or will be, sold or otherwise conveyanced in accordance with the present invention. Description 604 describes the property (e.g., by indicating the property location or other legal identifier). Market value 606 may be information identifying an appraised or agreed-upon market value of the property identified by property identifier 602. For example, the value may be established by agreement between the owner of the property, a primary investor, and a secondary investor. As another example, the value may also be established by agreement between the owner of the property and a lender. The information in database 600 may be used to generate and convey fractionalized interests and recombination rights pursuant to embodiments of the present invention.

Transaction Database

Referring to FIG. 8, a table represents a transaction database 700 that may be stored at the transaction device 500. The table includes entries identifying transactions that have been executed in accordance with techniques of the present invention. The table also defines fields 702-714 for each of the entries. The fields specify: a transaction identifier 702, a property identifier 704, terms of a first interest 706, a taker of the first interest 708, terms of a second interest 710, a taker of the second interest 712, and terms of a recombination right 714. The information in the transaction database 700 may be created and updated, for example, based on information received from a seller, a primary investor, a secondary investor, an intermediary or broker, and/or other participants in a transaction pursuant to embodiments of the present invention.

Transaction identifier 702 may be, for example, an alphanumeric code associated with a particular transaction that was executed in accordance with the present invention.

Property identifier 704 may be, for example, the same as or related to property identifier 602 of property database 600, or it may be other information used to identify a particular property which is conveyed in the transaction identified by transaction identifier 702.

Terms of first interest 706 may be, for example, information identifying one or more terms of the first fractionalized interest established using techniques of the present invention. For example, terms in 706 may include terms identifying a price of the first fractionalized interest, a duration, warranty terms, and any other term necessary to fully identify the scope of the first fractionalized interest created pursuant to embodiments of the present invention.

Taker of the first interest 708 may be, for example, information identifying the taker of the first fractionalized interest identified by 706. Using the nomenclature introduced above, information in 708 identifies primary investor 120.

Terms of the second interest 710 may be, for example, information identifying one or more terms of the second fractionalized interest established using techniques of the present invention. For example, terms in 710 may include terms identifying a price of the second fractionalized interest, a duration, warranty terms, and any other term necessary to fully identify the scope of the second fractionalized interest created pursuant to embodiments of the present invention. Taker of the second interest 712 may be, for example, information identifying the second fractionalized interest identified by 710. Using the nomenclature introduced above, information in 712 identifies the secondary investor.

In some embodiments, more than two fractionalized interests may be utilized to convey a property. In such embodiments, table 700 may include further fields identifying the terms and takers of the additional fractionalized interests.

Terms of recombination right(s) 714 may include, for example, information identifying terms defining the recombination right(s) generated pursuant to embodiments of the present invention. For example, information in 714 may identify the price of a recombination right as well as the conditions to exercise the right. In some embodiments, recombination right(s) used pursuant to embodiments of the present invention may include other common law or contract rights such as condition(s) subsequent, reversions, conditional limitations, or the like which may be structured in financings pursuant to embodiments of the invention to terminate a first property interest. In some embodiments, recombination right(s) used pursuant to embodiments of the present invention may require the taking of some action, or the happening of a particular event or set of events to occur (e.g., a reentry, etc.). Terms of such recombination right(s) are set forth, in some embodiments, as item 714.

Upon reading this disclosure, those skilled in the art will appreciate that other data and information may be provided in property database 600 and transaction database 700 as needed to identify, track, price, create and otherwise evaluate fractionalized interests and recombination rights pursuant to embodiments of the present invention.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Pursuant to some embodiments of the present invention, pricing and evaluation tools may be utilized to facilitate pricing, selection, and evaluation of transactions. For example, these pricing and evaluation tools may be implemented using computing devices to allow the efficient and accurate pricing and evaluation of different transaction structures. In some embodiments, these pricing and evaluation tools may be presented to users over a network interface, such as, for example, via the Internet. In some embodiments, the tools may be provided as local software applications or the like.

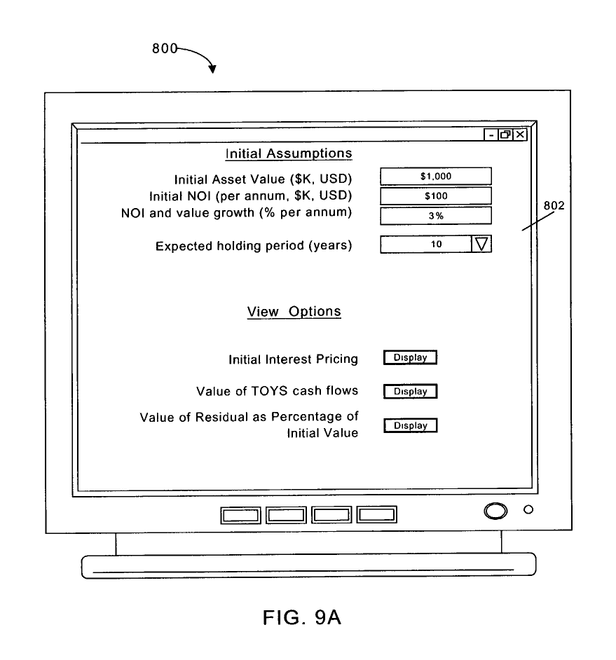

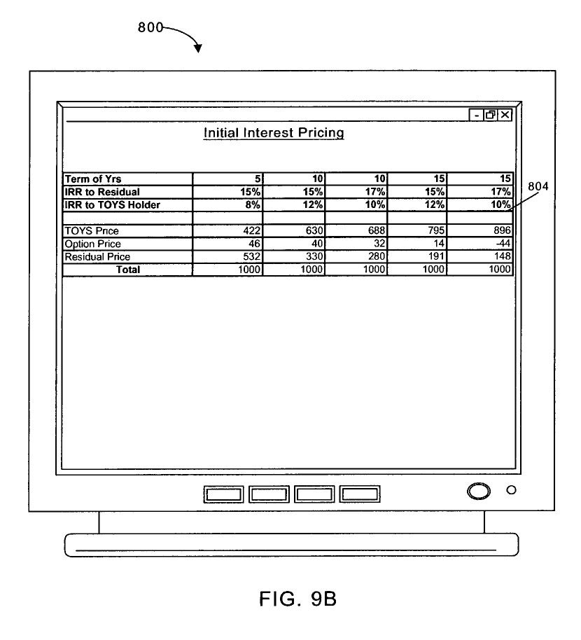

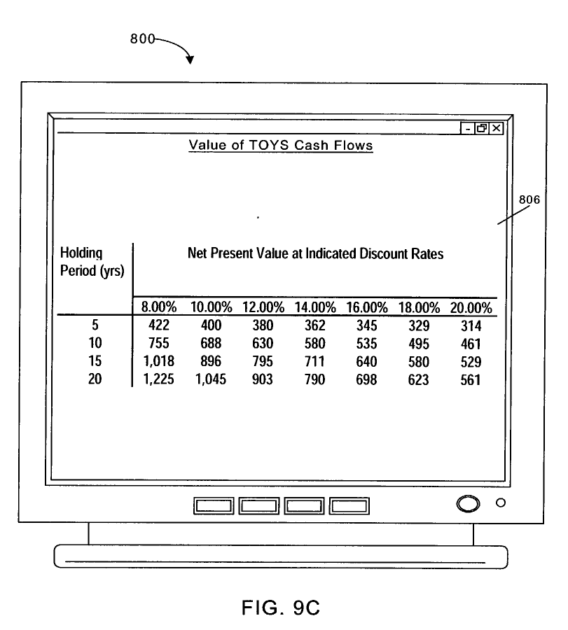

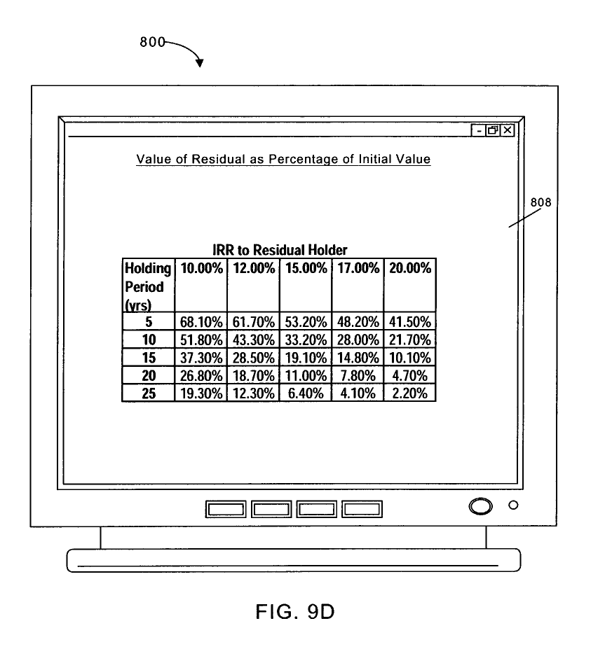

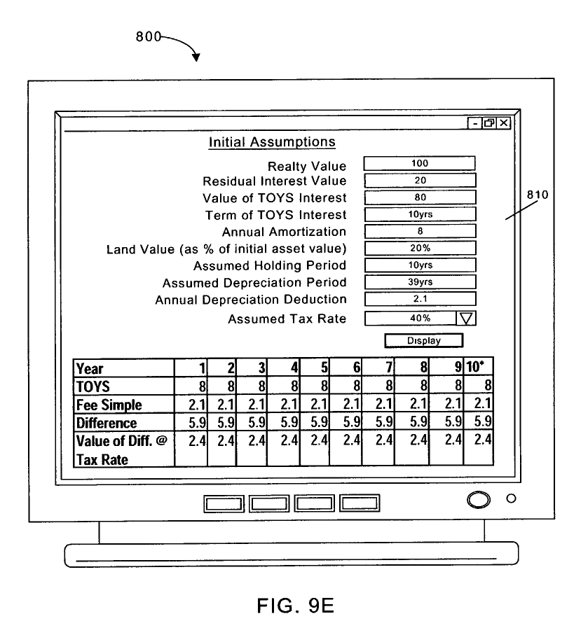

Examples of user interfaces of exemplary pricing and evaluation tools will now be provided by reference to FIGS. 9A-9e. Those skilled in the art will recognize that the configuration and layout of these user interfaces may be modified or adapted to provide different combinations of information to users.

Reference is first made to FIG. 9A, where a user interface 800 is depicted which may be presented to a user who is attempting to decide whether to finance a transaction using conventional financing techniques or using a term of years financing pursuant to the present invention. User interface 800 is configured to provide pricing information for commercial properties (e.g., properties enjoying operating income from, for example, rent-paying tenants). Those skilled in the art will recognize that other types of pricing and evaluation interfaces may be provided to price and evaluate other types of properties or assets.

In interacting with user interface 800 of FIG. 9A, a user may be prompted to enter information about several assumptions, including, for example: (1) an initial value of the asset to be financed; (2) an initial net operating income (NOI) of the asset (e.g., rents or lease income); (3) NOI growth rates; and (4) one or more expected holding periods. As depicted, the user interface 800 is configured to allow the user to select three different displays for viewing once the initial assumptions are entered (e.g., the user can choose to view initial interest pricing; the value of the TOYS cash flows; or the value of the residual interest as a percentage of the initial value). Each of these displays is depicted as items 804, 806, 808 in FIGS. 9B, C and D, respectively. This information may be employed by a user to configure and/or evaluate a transaction pursuant to embodiments of the present invention.

For example, referring to FIG. 9B, the user interacting with user interface 800 may view various pricing alternatives of a transaction based on the input assumptions entered into screen 802 of FIG. 9A. As depicted, various initial interest pricing rates have been calculated (representing present values of cash flows at the indicate discount rates). A user may identify one or more transaction configurations which suit a desired return and a desired initial pricing (to both the term of years interest holder as well as to the residual holder).

Referring to FIG. 9C, the user interacting with user interface 800 may view further details of the net present value of the term of years interest for various discount rates. Referring to FIG. 9D, the user interacting with the user interface 800 may view further details of the value of the residual as a percentage of the initial value for various holding periods.

Other tools and screens may also be used to assist in the evaluation of transactions pursuant to embodiments of the present invention. For example, referring to FIG. 9E, a user interface 800 may be provided which allows a user to compare a transaction pursuant to embodiments of the present invention with a conventional financing. A number of assumptions are entered and a comparison of the two transactions for each year in a holding period are displayed. In this manner, an investor may compare the relative value of the two alternatives to identify the alternative having the greatest value. Those skilled in the art will appreciate that other pricing and analysis tools may be used to construct and evaluate transactions pursuant to embodiments of the present invention.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for financing the ownership or acquisition of property, comprising:
identifying a fractional interest in said property;
identifying a recombination right in said property;
pricing said fractional interest and said recombination right; and
transferring said property upon receipt of a price of said fractional interest and said recombination right.

2. The method of claim 1, wherein said fractional interest is a term of years interest.

3. The method of claim 2, wherein said term of years interest is a term of less than or equal to 10 years.

4. The method of claim 2, wherein said term of years interest is a term greater than or equal to 10 years.

5. The method of claim 2, further comprising:
identifying a second fractional interest in said property.

6. The method of claim 5, wherein said second fractional interest is a future interest in said property, said future interest vesting at an end of said term of years interest.

7. The method of claim 6, wherein said recombination right is an option to acquire said future interest in said property.

8. The method of claim 7 wherein said recombination right is a right having a legal effect of terminating a holder's interest or estate in property selected from at least one of:
a condition subsequent conditional limitation;
a reverter; and
acontractual provision.

9. The method of claim 7, wherein a price of said recombination right is determined based at least in part on a desired return on investment for a holder of said second fractional interest.

10. The method of claim 5, wherein said second fractional interest is a residual interest and said recombination right is at least one of: an option to acquire said residual interest; a condition subsequent conditional limitation; a reverter; and a contractual provision.

11. The method of claim 1, further comprising:
identifying at least a second fractional interest in said property, and wherein said recombination right includes a right to recombine said fractional interest and said at least second fractional interests.

12. The method of claim 1, further comprising:
determining if said pricing is acceptable to parties to said transfer; and
if said pricing is not acceptable to parties to said transfer, repeating said identifying a fractional interest, identifying a recombination right, and pricing until said pricing is acceptable to said parties.

13. The method of claim 12, wherein said parties to said transfer include a seller and a taker of said fractional interest.

14. A method for a buyer to acquire an asset, comprising:
identifying a first fractional interest in said asset, said first fractional interest to be held by said buyer;
identifying a second fractional interest in said asset, said second fractional interest to be held by a third party; and
identifying a recombination right in said asset, said recombination right allowing said buyer to acquire said second fractional interest from said third party upon specified terms.

15. The method of claim 14, further comprising:
purchasing said first fractional interest from a seller of said asset; and
purchasing said recombination right from said seller of said asset.

16. The method of claim 15, wherein a price of said first fractional interest is determined based at least in part on terms of said second fractional interest.

17. The method of claim 14, wherein a price of said second fractional interest is determined based at least in part on terms of said first fractional interest.

18. The method of claim 14, wherein a price of said recombination right is based at least in part on terms of said first and said second fractional interests.

19. The method of claim 14, wherein a price of said recombination right is based at least in part on the return on investment desired by said third party.

20. The method of claim 14, further comprising:
transferring said asset to said buyer subject to said second fractional interest.

21. A method for selling an asset to a buyer, comprising:
receiving a request to purchase said asset;
offering a first fractional interest in said asset to said buyer at a first price;
offering a second fractional interest in said asset to an investor at a second price;
offering a recombination right to said buyer at a third price; and
conveying said first fractional interest and said recombination rights to said buyer and said second fractional interest to said investor.

22. The method of claim 21, wherein a sum of said first price, said second price and said third price is greater than a market value of said asset.

23. The method of claim 21, wherein said first fractional interest is a term of years interest in said asset.

24. The method of claim 21, wherein said second fractional interest is a future interest.

25. The method of claim 21, wherein said recombination right is an option to acquire said second fractional interest.

26. A method for facilitating the sale of an asset from a seller to a buyer, comprising:
identifying a first fractional interest in said asset to be held by said buyer;
identifying a second fractional interest in said asset to be held by an investor;
identifying a recombination right allowing said buyer to acquire said second fractional interest from said investor;
pricing said first fractional interest, said second fractional interest, and said recombination right; and
conveying said asset from said seller to said buyer.

27. A computer-implemented method performed by a seller to facilitate sale of an asset, comprising:
establishing a market value for said asset;
establishing terms of a first fractional interest in said asset, said first fractional interest to be conveyed to a buyer of said asset, said terms including a first price term
establishing terms of a second fractional interest in said asset, said second fractional interest to be conveyed to a third party, said terms including a second price term; and
establishing terms of a recombination right allowing said buyer to acquire said second fractional interest from said third party, said terms including a third price term;
wherein a sum of said first, second and third price terms is greater than said market value.

28. An apparatus, comprising:
a processor; and
a storage device in communication with said processor and storing instructions adapted to be executed by said processor to:
identify a fractional interest in a property;
identify a recombination right;
price said fractional interest and said recombination right; and
transfer said property to a buyer upon receipt of said price of said fractional interest and recombination right.

29. The apparatus of claim 28, wherein said storage device further stores at least one of: (i) a property database, and (ii) a transaction database.

30. The apparatus of claim 28, further comprising:
a communication device coupled to said processor and adapted to communicate with at least one of: (i) a seller device, (ii) an investor device, (iii) a buyer device, and (iv) a lender device.

31. A medium storing instructions adapted to be executed by a processor to perform a method of selling an asset, said method comprising:
identifying a fractional interest in a property;
identifying a recombination right;
pricing said fractional interest and said recombination right; and
transferring said property to a buyer upon receipt of said price of said fractional interest and recombination right.
